(19) United States
(12) Patent Application Publication
(10) Pub. No.: US 2007/0121810 A1
(43) Pub. Date: May 31, 2007

(54) Automatically Mixing Audio Signals in a Predetermined Manner

(75) Inventors: Edward Archibald, Iverness, CA (US); Spencer Brewer, Redwood Valley, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: HIGHWIRED TECHNOLOGIES, INC., Petaluma, CA (US)

(21) Appl. No.: 11/556,676

(22) Filed: Nov. 3, 2006

Related U.S. Application Data
(63) Continuation-in-part of application No. 11/533,349, filed on Sep. 19, 2006.
(63) Continuation of application No. 09/680,920, filed on Oct. 6, 2000, now abandoned.

(51) Int. Cl. H04M 1/64

(52) U.S. Cl. 379/67.1

(57) ABSTRACT

A first server mixes a first audio segment and a second audio segment, where the length in time of the second audio segment is longer than the length in time of the first audio segment. A database storing a plurality of soundscapes is coupled to the first server, the database. A second server coupled to the first server provides a connection to the world-wide web (WWW). An audio clip created by receiving a voice message as the first audio segment and retrieving a soundscape as the second audio segment. The first audio segment and the second audio segment are mixed such that during the period of the first audio segment the volume of the second audio segment is substantially lowered below the volume of the first audio segment.

### CROSS REFERENCE TO RELATED APPLICATIONS

This application is a continuation-in-part of application Ser. No. 11/533,349, filed Sep. 19, 2006, pending, which is a continuation of application Ser. No. 09/680,920, filed Oct. 6, 2000, pending.

### BACKGROUND

1. Field of the Invention

The present invention relates to data communications. In particular, the present invention relates to delivering a mixed media message.

2. Background

The widespread acceptance and use of the Internet has generated much excitement, particularly among those who see the Internet as an opportunity to develop new avenues for communication. Many different types of communications are available over the Internet today, including email, IP telephony, teleconferencing and the like.

One application of the Internet that has received attention is adding multimedia capabilities to traditional email services. For example, such a system may provide a downloadable application which allows the user to record a voice message and send it as an email attachment. The email recipient then receives an email with an MP3-encoded audio file attached to it which can then be played with a standard media player. Some systems allow users to utilize a telephone and add a voice message that will be delivered along with the greeting, Still other systems allow the user to include an image, to record audio and to mix an existing audio file with the recorded audio.

While these systems perform their intended functions, they suffer from certain disadvantages. For example, in systems of the prior art, the mix is ‘flat’, that is, the user's recorded message and the audio file are mixed at ‘full volume’ for their entire length. Therefore, the resulting mixed audio file will not have a “professional” or polished sound and may result in the user's message being obscured by the background track.

Another disadvantage of prior art systems is that the audio file being used for the background mix will be included in its entirety. Hence, if the background file is 3 minutes long and the voice file is 10 seconds, the entire mix will be three minutes. Again, users will not perceive such a mix as professional and may be additionally frustrated by the time and bandwidth necessary to download unnecessary audio.

Hence, there exists a need to provide a mixed-message system which provides a professional-sounding product wherein the volume levels and length of the message are automatically mixed for the user by the system.

### SUMMARY

A method for automatically creating a mixed media message on a client node coupled to a host node over a network such as the Internet is disclosed. The method comprises choosing a soundscape; recording a message; and mixing the soundscape and the message in a predetermined manner. A host node is disclosed which is configured to provide a client node with the means for performing the method is disclosed. A client node is disclosed which is configured to receive means for performing the method is disclosed.

A recorded voice message having a first length and a background sound having a second length longer than the first length are received. The first length of the recorded voice message is determined. The level of a portion of the background sound is lowered, the lowered portion having a length that is substantially the same as the first length. The recorded voice message and the lowered portion of the background sound are interleaved. The length of the background sound is adjusted to the first length plus a third length.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 is a diagram of a mixed-messaging system according to the present invention.

FIG. 2 is a flowchart of a method of creating a mixed message according to the present invention.

FIG. 3 is a diagram of a soundscape according to the present invention.

FIG. 4 is a screenshot of the elements of a user interface (UI) according to the present invention.

FIG. 5 is a screenshot of the UI in the soundscape selection phase according to the present invention.

FIG. 6 is a screenshot of the UI in the message recording phase according to the present invention.

FIG. 7 is a screenshot of the UI in the mix preview phase according to the present invention.

FIG. 8 is a flowchart of mixing according to the present invention.

FIG. 9 is a diagram of a mixing template according to the present invention.

FIG. 10 is a flowchart of forwarding an audio clip according to the present invention.

### DETAILED DESCRIPTION

Persons of ordinary skill in the art will realize that the following description of the present invention is illustrative only and not in any way limiting. Other embodiments of the invention will readily suggest themselves to such skilled persons having the benefit of this disclosure.

It is contemplated that the present invention may be embodied in various computer and machine readable data structures. Furthermore, it is contemplated that data structures embodying the present invention will be transmitted across computer and machine-readable media, and through communications systems by use of standard protocols such as those used to enable the Internet and other computer networking standards.

The invention further relates to machine-readable media on which are stored embodiments of the present invention. It is contemplated that any media suitable for storing instructions related to the present invention is within, the scope of the present invention. By way of example, such media may take the form of magnetic, optical, or semiconductor media.

The present invention may be described through the use of flowcharts. Often, a single instance of an embodiment of the present invention will be shown. As is appreciated by those of ordinary skill in the art, however, the protocols, processes, and procedures described herein may be repeated continuously or as often as necessary to satisfy the needs described herein. Accordingly, the representation of the present invention through the use of flowcharts should not be used to limit the scope of the present invention.

The present invention may also be described through the use of web pages in which embodiments of the present invention may be viewed and manipulated. It is contemplated that such web pages may be programmed with web page creation programs using languages standard in the art such as HTML or XML. It is also contemplated that the web pages described herein may be viewed and manipulated with web browsers running on operating systems standard in the art, such as the Microsoft Windows® and Macintosh® versions of Internet Explorer® and Netscape®. Furthermore, it is contemplated that the functions performed by the various web pages described herein may be implemented through the use of standard programming languages such a Java® and similar languages.

The present invention will first be described through a diagram which illustrates the structure of the present invention, and then through figures which illustrate the operation of the present invention.

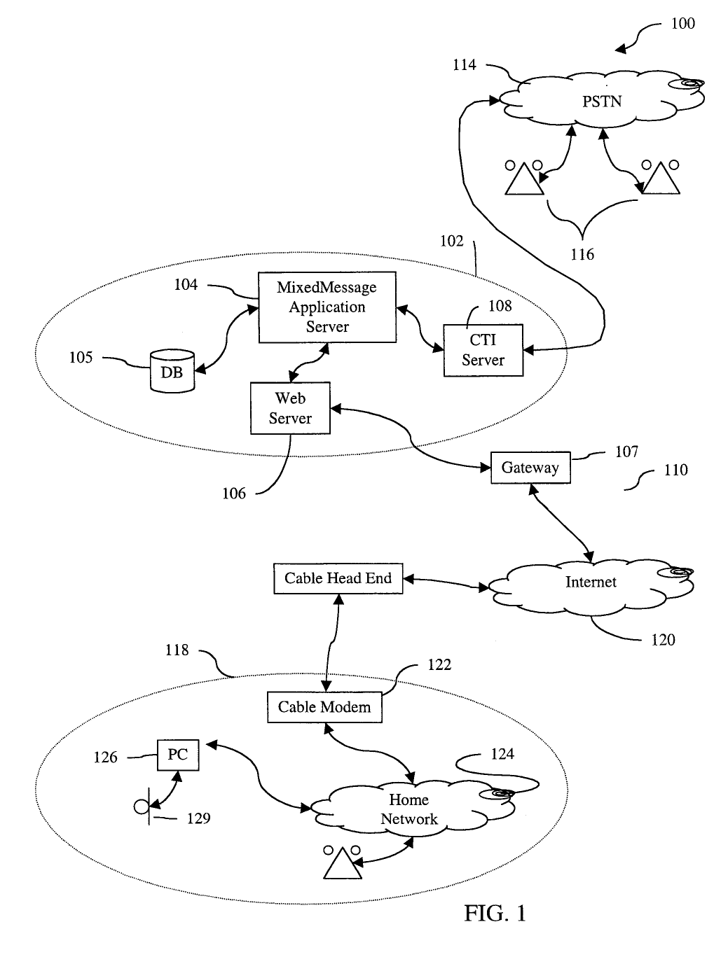

FIG. 1 is a diagram of a mixed-message system 100 according to the present invention. System 100 includes a host system 102 configured to host the present invention. It is contemplated that host 102 may comprise a server configured to run an operating system standard in the art such as Microsoft Windows®, Microsoft Windows® NT, or UNIX®, It is contemplated that host 102 may comprise a single server, or a plurality of servers operatively coupled over a network standard in the art.

Host 102 further includes an application server 104 configured to operate according to the present invention in a manner described in more detail below. Host 102 further includes a database 105 standard in the art for storing programs and media utilized in the present invention.

Host 102 further includes a web server 106 operatively configured to host a website. Web server 106 may comprise hardware and software standard in the art, and preferably is configured to interpret a language useful in Internet applications, such as JAVA®.

To couple the host 102 to the outside world, typically a gateway 107 standard in the art is provided and operatively coupled between web server 106 and backbone network 110. Backbone network 110 may be any packet-based network standard in the art, such as IP, Frame Relay, or ATM.

To provide additional communications to legacy POTS phone, host 102 may include a Computer-Telephony Integration Service (CTI) i08 configured to provide a telephony user interface (TUI) to users.

The system 100 of FIG. 1 also includes an example of a broadband residential client system 118. To reach individual residences, typically local ISP providers provide a cable or DSL head end 120 standard in the art. An individual wishing to utilize the ISP's service may then employ a cable modem or DSL modem 122 coupled to the user's home LAN 124. The user's home LAN may be provided by a home PC 126 configured to run software standard in the art such Microsoft Windows®. The user may then operatively couple an IP telephone 128 to the LAN 124 or directly to computer 126. The user may also operatively couple a microphone 129 directly to computer 126.

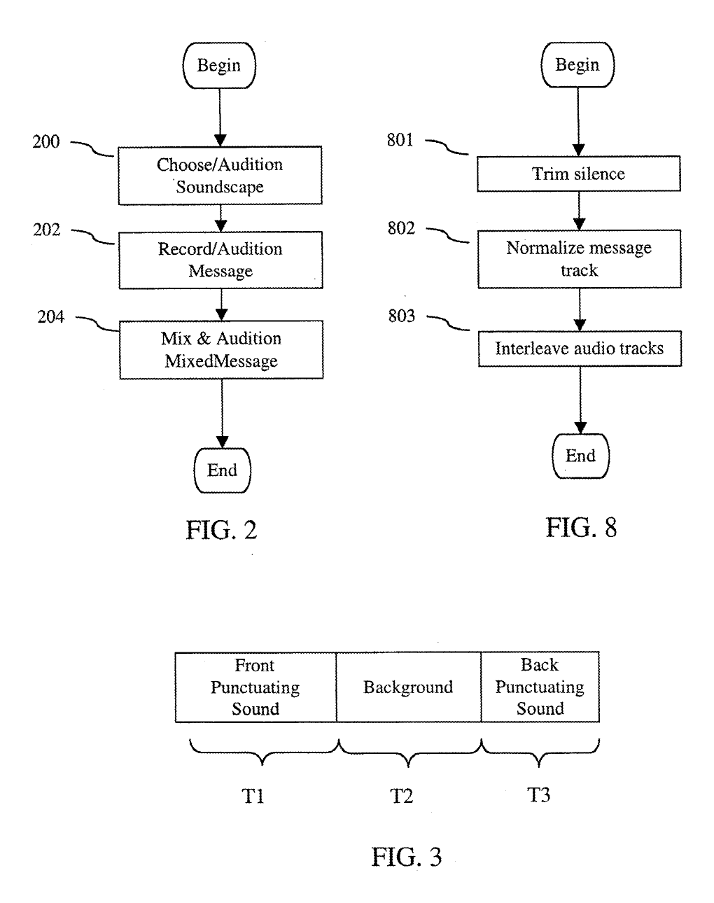

FIG. 2 is a flowchart of the creation of a MixedMessage according to the present invention. FIG. 2 provides an excellent overview of the process according to the present invention. In an exemplary non-limiting embodiment of the present invention, the process of FIG. 2 runs on a Windows® platform system including a microphone and speakers. Through the process as shown and described, the present invention creates an audio clip referred to herein as a MixedMessage.

Briefly, the process of FIG. 2 begins in act 200 where a user will select a soundscape. The user then records a message in act 202. Finally, the user mixes the soundscape and their recorded message together into a MixedMessage and previews the MixedMessage in act 204.

Referring now to FIG. 3, a diagram of a soundscape according to the present invention is shown. The soundscape of RG. 3 is represented as digital audio data composed of audio content occurring during time periods T1, T2, and T3. In an exemplary non-limiting embodiment of the present invention, time period T1 comprises a front punctuating sound (FPS), time period T2 comprises background audio, and time period T3 comprises a back punctuating sound (BPS). In an exemplary non-limiting embodiment of the present invention a soundscape which is comprised of three segments may be composed of three distinct digital audio files. Further, segments that are used to compose a given soundscape may be employed interchangeably in the composition of other soundscapes. Though the present example shows a three-section soundscape, it is contemplated that soundscapes may comprise a wide variety of content and themes.

By way of example, a soundscape having an ocean theme may comprise a FPS consisting of the surf crashing with the sound of seagulls calling in the distance; the background may consist of a continuation of the sound of the surf together with a romantic melody being played on an acoustic guitar; and the BPS consisting of the highlighted cry of a lone seagull.

An example of how a user may utilize the present invention over the Internet will now be shown and described.

The User Interface

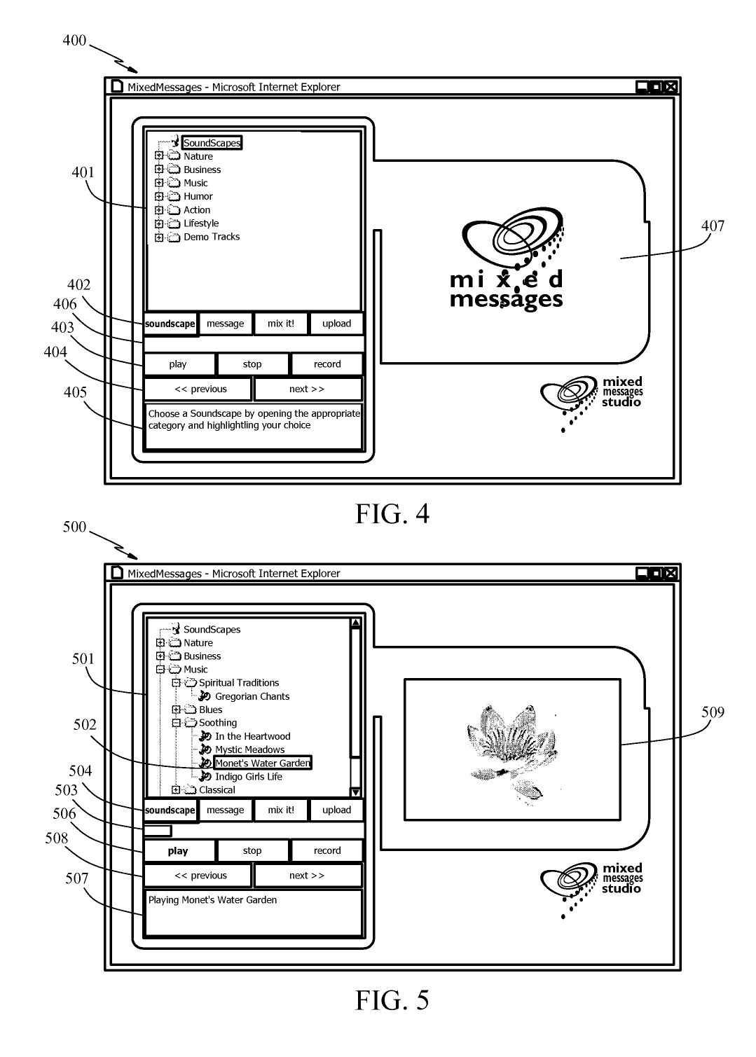

FIG. 4 is a screenshot of a user interface (UI) 400 according to the present invention. UI 400 may also include a plurality of components having corresponding functions. In an exemplary non-limiting embodiment of the present invention, these components are used throughout the operation of the invention and may have different functions depending on which ‘phase’ of the user is in.

The invention UI 400 includes a soundscape panel 401. Soundscape panel 401 is enabled to allow a user to select a soundscape. It is contemplated that soundscape panel 401 will conform to file selection standards according to the client node's operating system. By way of example, soundscape phase 401 is shown operating on a Windows®—compatible personal computer.

UI 400 further includes a phase indicator panel 402. In an exemplary non-limiting embodiment of the present invention, phase indicator panel 402 indicates the user's progress in achieving the steps of the present invention as shown and described in FIG. 2.

UI 400 may also be enabled with media control buttons 403 which control the operation of playback or recording of the present invention depending on the application phase. UI 400 may also have navigation buttons 404 standard in the art which allow the user of the application to move, at appropriate times, between the phases of the application. UI 400 may also include a context sensitive help/status panel 405 standard in the art which allows the user to receive help on the operation of the application and on the current operational status of the application. UI 400 may also include a sound recording/playback progress panel 406 that indicates the current progress of playback or recording as a ‘percentage complete’ indicator.

UI 400 may also include an image display panel 407 that displays an image corresponding to the selected soundscape.

Choosing a Soundscape

The first step of the present invention is to choose a soundscape.

FIG. 5 is a screenshot of the invention UI in the soundscape selection phase 500 according to the present invention. It is contemplated that soundscape selection phase 500 will be displayed to a user on a client node which is operatively coupled to a host node which is configured according to the present invention. In an exemplary non-limiting embodiment of the present invention, the invention UI soundscape selection phase 500 and the rest of the phases to follow are generated on a client node using hardware and software standard in the art, such as JAVA and a JAVA®—enabled web browser running on a personal computer.

The soundscape selection phase 500 includes a soundscape panel 501, a phase indicator panel 504, media control buttons 506, navigation buttons 508, context sensitive help/status panel 507, and a sound recording/playback progress panel 503, which function in a manner substantially similar to that of FIG. 4.

The soundscape selection phase 500 may also include an image display panel 509 that displays an image corresponding to the selected soundscape.

As can be seen by inspection of FIG. 5, soundscapes according to the present invention are organized into a plurality of Genre folders within the soundscape panel 501. In an exemplary non-limiting embodiment of the present invention, double-clicking on any of the soundscape Genre folders in the soundscape panel 501 or clicking on the ‘+’ opens the folder to display a further set of folders at an ‘Edition’ level.

In an exemplary non-limiting embodiment of the present invention, when a user has opened an ‘Edition’ level folder, the user will be presented with one or more available soundscapes as indicated by a speaker icon or other suitable indicator. As can be seen by inspection of FIG. 5, the “Monet's Water Garden” soundscape 502 has been selected. In an exemplary non-limiting embodiment of the present invention, when a user has selected a given soundscape a corresponding image may displayed in the image display panel 509. In an exemplary non-limiting embodiment of the present invention, the image may be downloaded from the host web server.

Thus, in the example shown in FIG. 5, the user has chosen the “Monet's Water Garden” soundscape 502 from the “Soothing” Edition of the “Music” Genre.

It is important to note that the various soundscapes may be sorted within soundscape selection panel 501 by emotional characteristics or other methods. Additionally, soundscapes may be organized by pictures or other indicators such as icons. Additionally, soundscapes and other sources of sounds may be presented by completely different means independent of such a hierarchical representation.

In an exemplary non-limiting embodiment of the present invention, the soundscapes are stored on a media database on the host server and when the user selects a particular soundscape, that soundscape is presented to the client by ‘streaming’ highly compressed digital audio data to the client to minimize any delay. In an exemplary non-limiting embodiment of the present invention, the soundscape components (i.e. ITS, BG and BPS) are streamed in MP3 format and are converted, on the client, into raw PCM data. In an exemplary non-limiting embodiment of the present invention, the soundscape components will be stored in the RAM of the client node and ultimately played for the user.

A user may select a particular soundscape by single-clicking on it and then can control the playback of the soundscape by using the media control buttons 506. At any given time, the soundscape that is highlighted in the soundscape panel becomes the soundscape that will be used in other phases of the MixedMessage creation and use.

As can be seen by inspection of FIG. 5, the button labeled ‘soundscape’ of phase indicator panel 504 is highlighted to indicate that the user is in the soundscape selection phase.

FIG. 5 as shown and described provides an example of means for selecting a soundscape.

Recording a Message

The next step is for the user to record a message.

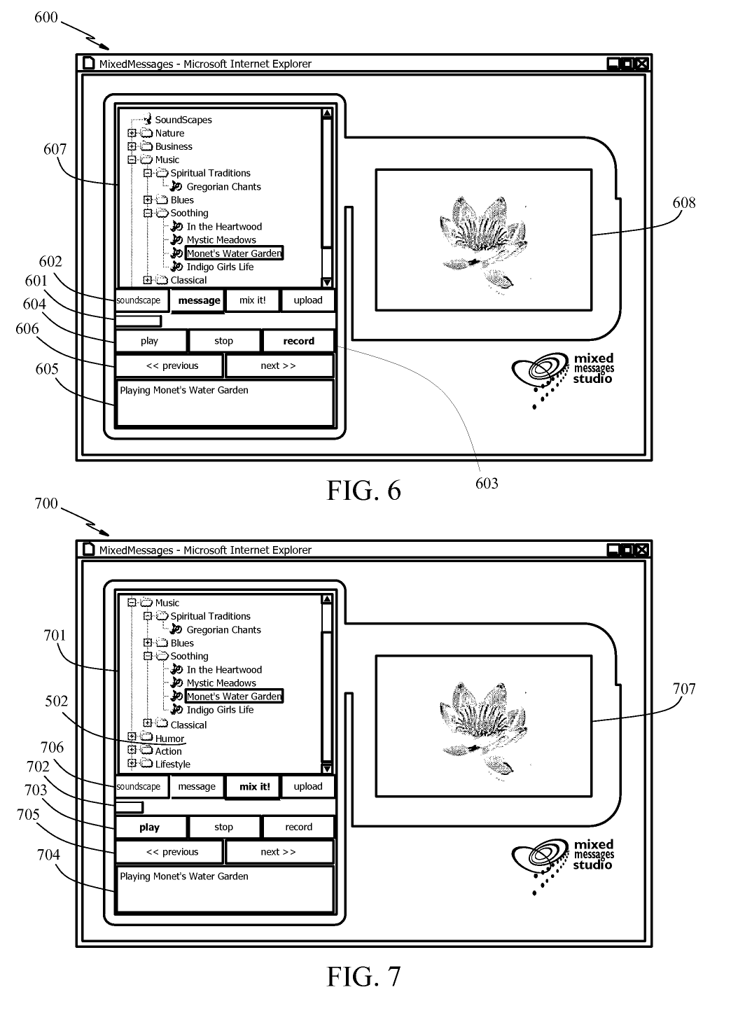

FIG. 6 is a screenshot of the UI in the recording phase 600 according to the present invention. It is contemplated that the recording phase 600 will be displayed to a user on a client node which is operatively coupled to a host node which is configured according to the present invention.

By way of example, recording phase 600 is shown operating on a Windows®—compatible personal computer running a JAVA®—enabled web browser.

The recording phase 600 includes a soundscape panel 607, a phase indicator panel 602, media control buttons 604, navigation buttons 606, context sensitive help/status panel 605, and a sound recording/playback progress panel 601, which all function in a manner substantially similar to that of FIG. 4.

The recording phase 600 may also include an image display panel 608 that displays an image corresponding to the selected soundscape.

To start recording, the user may click the ‘record’ button 603 in the media control buttons 604. In an exemplary non-limiting embodiment of the present invention, recording commences immediately and continues until the user presses the ‘stop’ button in media control button section 604. The user can then audition the recorded message utilizing he play, pause and stop buttons in media control button section 604.

In an exemplary non-limiting embodiment of the present invention, the user's voice is recorded using standard hardware and software on the user's computer. In a presently preferred embodiment, the present invention performs necessary media control functions by interfacing with the user's PC using a protocol such a Direct-XB. In an exemplary non-limiting embodiment of the present invention, the voice data is stored in RAM memory in PCM format. For permanent storage, the voice data may be stored as a .wav file on the client node.

In an exemplary non-limiting embodiment of the present invention, the user may indicate that they are satisfied with their message and are ready to move on to the next step by pressing the control button 606 or the appropriate application phase indicator button 602.

As can be seen by inspection of FIG. 6, the button labeled ‘message’ of phase indicator panel 602 is highlighted to indicate that the user is in the record phase.

Additionally, the bar in sound recording/playback progress panel 601 has lengthened to indicate the user's further progress through the present invention.

The recording phase 600 as shown and described provides an example of means for recording a message.

Mixing

The next step is to mix the chosen soundscape with the recorded message.

FIG. 7 is a screenshot of the invention UI in the mix review phase 700 according to the present invention. It is contemplated that mix review phase 700 will be displayed to a user on a client node which is operatively coupled to a host node which is configured according to the present invention.

By way of example, mix review phase 700 is shown operating on a Windows®—compatible personal computer running a JAVA®—enabled web browser.

The mix review phase 700 includes a soundscape panel 701, a phase indicator panel 706, media control buttons 703, navigation buttons 705, context sensitive help/status panel 704, and a sound recording/playback progress panel 702, which function in a manner substantially similar to that of FIG. 4.

The mix review phase 700 may also include an image display panel 707 that displays an image corresponding to the selected soundscape.

In an exemplary non-limiting embodiment of the present invention, the user initiates the mixing process by clicking on the ‘play’ button in media control buttons 703. The present invention then mixes the recorded message and the chosen soundscape in a predetermined manner. In an exemplary non-limiting embodiment of the present invention, the soundscape is streamed from the server, decoded, and stored in the client's RAM; the recorded message is then read from the client node's RAM; and all of the aforementioned components are then mixed in a predetermined manner and immediately played for the end user as audio. The progress of the mixing process may be displayed to the user through progress indicator 702.

In preferred embodiments, the actual mix takes place in real time and the end user hears the result immediately. By performing the mixing process on the client node, the present invention allows the mixing process to occur in real time. This immediacy of the end-user feedback is a significant improvement over systems of the prior art and provides users with increased convenience. For example, in systems utilizing the present invention, users may then choose different soundscapes with their recorded message, and hear the preview immediately.

In an exemplary non-limiting embodiment of the present invention, the recorded voice message is processed using audio processing tools standard in the art prior to the mixing process.

As can be seen by inspection of FIG. 7, the button labeled ‘mix it!’ of phase indicator panel 706 is highlighted to indicate that the user is in the nix and review phase.

The mixing phase 700 as shown and described provides an example of means for mixing and reviewing a message.

FIG. 8 is a flowchart of a method for mixing a soundscape and a recorded message according to the present invention, The process of FIG. 8 may be performed by media tools standard in the art running on the client node. In an exemplary non-limiting embodiment of the present invention, the length of the recorded message may also be determined for use with other aspects of the present invention.

The process of FIG. 8 begins with the present invention examining the recorded message and removing any silence from the beginning and end of the recorded message in act 800. In an exemplary non-limiting embodiment of the present invention, act 800 is performed using audio gating tools standard in the art.

The process of FIG. 8 continues with the recorded message being normalized in act 802. As is appreciated by those of ordinary skill in the art, the process of normalization involves the use of compression and limiting tools which adjust the peak and average levels of an audio signal in a predetermined manner, thus giving an audio signal a “studio” quality. In an exemplary non-limiting embodiment of the present invention, act 802 may be performed using compression/limiter tools standard in the art.

The process of FIG. 8 concludes with act 804, where the present invention interleaves the gated and normalized recorded message with the chosen soundscape in a predetermined manner.

It is contemplated that other acts may be performed during the mixing process in addition to those listed in FIG. 8. For example, additional process steps such as trimming or harmonizing may be performed on the recorded message; the length of the voice track may be calculated; the mix contours for all tracks may be calculated, such as the starting offset, volume changes, ramp up and ramp down time, and ending offset as will be further described below. Additionally, the present invention may initiate streaming of the user's recorded message back to the host server, or output the result of the mix to a digital audio file on the client node

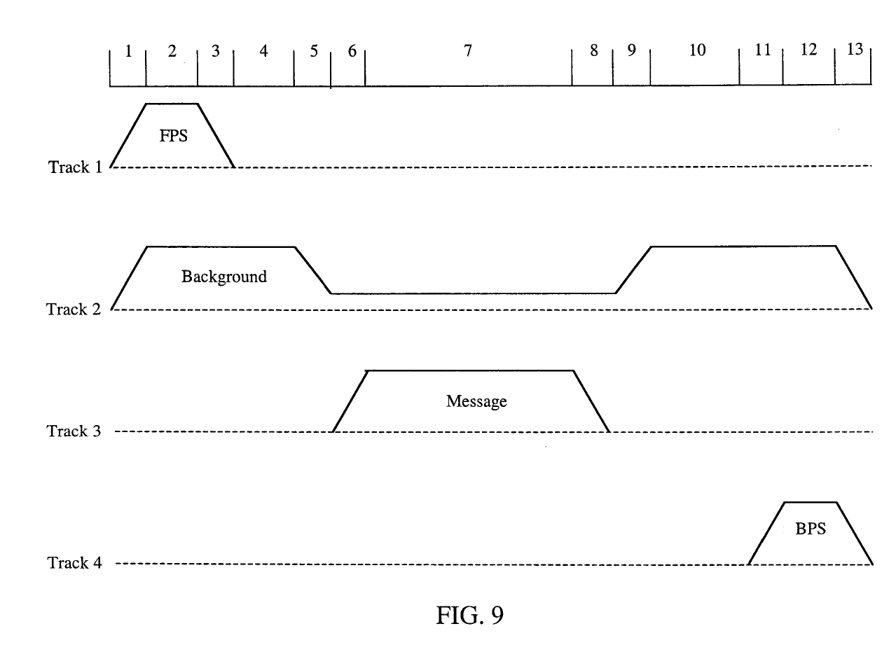

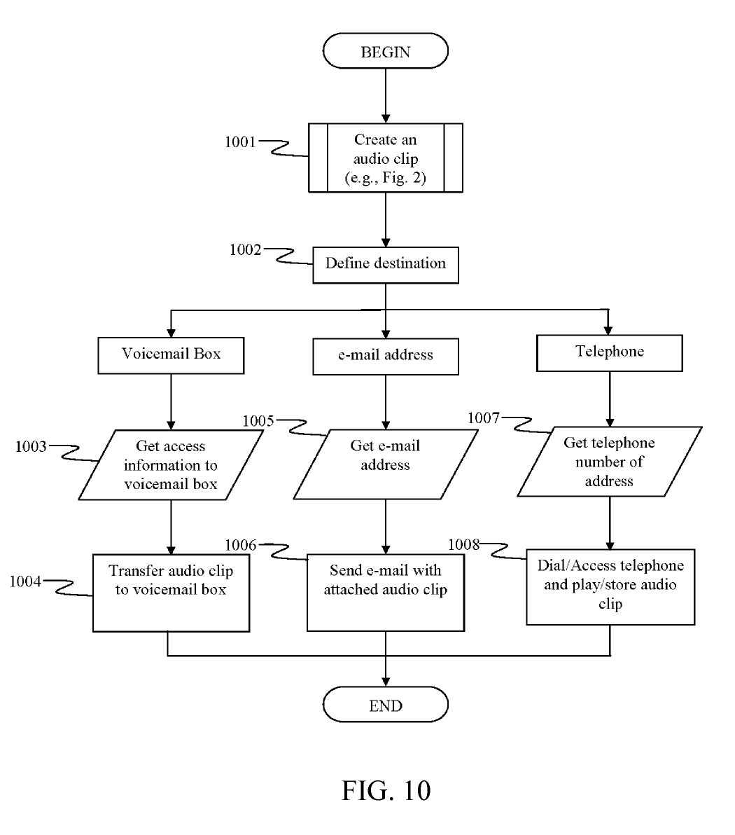

FIG. 9 is a diagram of an interleaving process according to the present invention. FIG. 9 demonstrates how the various audio tracks which comprise a MixedMessage are assembled into a final product. FIG. 9 shows each individual track with its corresponding level contour all displayed along a common time axis, with particular time intervals of interest numerically indicated along a top time axis.

FIG. 9 shows one aspect of the present invention where a front punctuating sound, a background, a recorded message, and a back punctuating sound are interleaved together to form a MixedMessage. As can be seen by inspection of FIG. 9, each individual track has a corresponding contour, where each contour has a corresponding level and time offset. The overall effect of the tracks and their corresponding contours may be said to form a MixedMessage template.

It is contemplated that a MixedMessage template may comprise any number of individual tracks. It is further contemplated that each individual track may consist of any multimedia information suitable for display or presentation to a user. Though the present example consists of audio information be interleaved, it is contemplated that each audio track may consist of a sub-mix of audio information mixed in a previous mixing process. It is further contemplated that other media, such a video information, may be included in the process of the present invention.

Referring back to FIG. 9, and more specifically to track 1, the front punctuating sound (FPS) is first mixed in. In an exemplary non-limiting embodiment of the present invention, the FPS is mixed in by bringing the FPS into the mix by raising its level at a predetermined rise time during time interval 1. The level of the FPS is then held for a predetermined length of time during time interval 2, then the FPS is removed from the mix by dropping its level at a predetermined fall time during time interval 3. In a presently preferred embodiment, time interval 1 lasts approximately 0.1 seconds, time interval 2 lasts approximately 1 to 3 seconds, and time interval 3 lasts approximately 0.1 seconds.

Referring now to track 2, the background is mixed in a manner similar to the FPS during time intervals 1-4. However, during time interval 5, the background level is lowered to a predetermined level at time interval 5. In a presently preferred embodiment, the background is lowered to a non-zero level until time interval 8, referred to as the bed volume. In an exemplary non-limiting embodiment of the present invention, the bed volume is approximately 10-18 dB below the level of the recorded message. Referring now to track 3, the recorded message is mixed in during time interval 6 by raising the level of the message at a predetermined rise time. The message is then played for its predetermined length during time interval 7. The message is then removed from the mix by lowering its level at a predetermined fall time during time interval 8.

After the message has concluded in time interval 8, the background level is then raised at a predetermined rise time during time interval 9, and then may be played for a predetermined amount of time during time interval 10.

Referring now to track 4, the back punctuating sound (BPS) may be brought into the mix by raising its level at a predetermined rise time during time interval 11. The BPS level may then be maintained for a predetermined amount of time during time interval 12. Finally, to conclude the MixedMessage, both the BPS and the background may be mixed down by lowering their levels at a predetermined fall time during time interval 13.

As can be seen by inspection of FIG. 9, the template according to the present invention may be characterized as mixing predetermined information around a message provided by a user.

FIGS. 7, 8 and 9 as shown and described provide examples of means for mixing a soundscape and a recorded message into a MixedMessage,

After the processes described above are complete, additional acts may be performed. For example, when the user is satisfied with the result, an upload phase may generate an XML document which describes in detail all of the elements of the MixedMessage, including for example, the contours as shown and described in FIG. 9. This XML document is then sent to the MixedMessages Application Server and represents instructions by which the host node may reproduce the exact mix chosen by the user on the client node. The MixedMessage may then be stored as a .wav file in the database on the host. It is contemplated that the actual mix process, the storage of the file, additional audio processing during the mix, output file conversion to different formats may take place on the host node.

The finished MixedMessage produced according to the present invention may then be used in a variety of manners. For example, in an exemplary non-limiting embodiment of the present invention, the MixedMessage is an audio clip that can be uploaded to a voice mail system chosen by the user for use as a voice mail greeting. The MixedMessage may also be used to create an “intentional message” to be sent to a recipient's voice mailbox. In yet another aspect of the present invention, the MixedMessage may be utilized to create an email message which includes the MixedMessage along with associated text and the chosen image.

Once an audio clip is prepared the user may cause, through the web page interface discussed in more detail above, the sending of the audio clip to a desired destination. These may include, but are not limited to, an internet protocol address, an e-mail address, the voice mail box of the user creating the audio clip, or a telephone number. The telephone number may be of a wired or cellular phone. FIG. 10 shows a flowchart of forwarding an audio clip according to the present invention. In 1001 an audio clip is created in accordance with the disclosed invention, for example, as shown with respect to FIG. 2 above. In 1002 the destination is defined as, for example, one of the user voicemail box, an e-mail address, a telephone number, or any applicable destination address. According to the specific selection the method continues in the desired direction. If the audio clip is destined to the user's voicemail box then in 1003 the system requests access information enabling the access to the user voicemail box. Specifically, CTI server 108 may initiate a session with a voicemail system (not shown) which is part of PSTN 114. Once access to the voicemail box of the user is accomplished the audio clip is transferred into the user's voicemail box, for example, as an outgoing voice message. If the audio clip is destined to an e-mail address then in 1005 the e-mail address is to be provided to the system. In 1006, responsive of receiving the e-mail address, the audio clip is attached to an e-mail message containing the e-mail address, and the e-mail is sent by, for example, means of web server 106, through gateway 107 to the Internet 120 which then directs the e-mail message to its desired destination. If the destination is a telephone then the telephone number or the telephone IP address, are provided to the system in 1007. In 1008, if a telephone number is provided then CTI server 108 dials PSTN 114 to access the desired telephone number and play or store, if direct access to a voicemail box of the destination is available, the audio clip. If an IP address is provided instead of a telephone number, the web server 106 initiates a communication session with the IP telephone and when connection is established plays the audio clip.

In one embodiment of the disclosed invention the audio clip is retained, for example, in database 105. The user receives a universal resource locator (URL) to the stored audio clip, allowing for access, for example for the purpose of replay, to the stored audio clip. Specifically, web server 106 would receive a request to access the audio clip by using the URL. In response to such a request web server 106 retrieves the desired audio clip from database 105 and delivers it to the desired destination.

It is further contemplated that during the recording and creation of the MixedMessage, additional processes may take place, also. For example, it is contemplated that the user may manually modify the contours of the interleaving process. This modification may be accomplished by presenting the user with controls presented during the mixing phase which may be used to adjust the level and time contours, for example.

Furthermore, it is contemplated that the user may also modify the recorded message with processing tools to enhance or modify the voice information. For example, the user may be able to make their voice sound similar to that of a popular character or celebrity. It is contemplated that this procedure may be accomplished by presenting the user with audio processing tools during the recording or mixing/audition phases.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed is:

1. A system for creating an audio clip comprising:
a database storing a plurality of soundscapes;
a first server coupled to the database, the first server to create the audio clip by
receiving a voice message as a first audio segment having a first length,
retrieving a soundscape as a second audio segment from the plurality of audio soundscapes, the second audio segment having a second length longer than the first length,
mixing the first audio segment and the second audio segment such that during the period of the first audio segment the volume of the second audio segment is lowered to a bed volume; and,
a second server coupled to the first server, the second server to provide a connection to the world-wide web (WWW).

2. The system of claim 1, wherein the voice message is received from the second server.

3. The system of claim 1, wherein audio clip is stored in the database.

4. The system of claim 1, wherein the second server further comprises:
memory containing a web page for display on a user terminal, sent to the user terminal responsive to an access to the second server by the user, the web pages designed to display on the user terminal a user interface enabling the user to interact with the system.

5. The system of claim 4, wherein the web page contains at least one of:
a recorder enabling recording of the voice message;
a selection area allowing the user to select the soundscape from the plurality of soundscapes; or,
a player enabling at least one of: playing the soundscape, playing the voice message, or playing the audio clip.

6. The system of claim 5, wherein the selection area provides a list of soundscape genres and a list of soundscapes within the soundscape genre selected by the user.

7. The system of claim 5, wherein the selection area provides a list of soundscape genres, each genre providing a list of editions, each edition providing a list of soundscapes within the soundscape edition of the soundscape genre selected by the user.

8. The system of claim 5, wherein the web page further enables:
sending of the audio clip to a user defined destination.

9. The system of claim 8, wherein the user defined destination is at least one of: an internet protocol address, an e-mail address, a telephone number, or a voicemail box.

10. The system of claim 1, further comprising:
a third server coupled to the first server to provide a connection to a public switched telephone network (PSTN).

11. The system of claim 10, wherein the voice message is received from one of the second server or the third server.

12. The system of claim 10, wherein the PSTN further comprises a voicemail box subsystem.

13. The system of claim 12, wherein the third server is further to send the audio clip to a voicemail box of the user.

14. The system of claim 13, wherein the third server uses user verification information for the purpose of accessing the voicemail box of the user.

15. The system of claim 1, wherein said second server is enabled to assign a unique universal resource locator (URL) to the audio clip.

16. The system of claim 1, wherein the bed volume is between 10 and 18 dB below the volume level of the first audio segment.

17. A method for creating an audio clip comprising:
receiving a first audio segment comprising a voice message recorded by a user, the user providing the first audio segment by accessing a web page;
retrieving a soundscape selected by the user as a second audio segment, the second audio segment being longer than the first audio segment, the user selecting the soundscape from a plurality of soundscapes by accessing the web page;
mixing the first audio segment and the second audio segment such that during the period where the first audio segment is played the volume of the second audio segment is lowered to a bed volume, thereby creating the audio clip; and
directing the audio clip to a destination selected by the user by accessing the web page.

18. The method of claim 17, wherein the bed volume is between 10 and 18 dB below the volume level of the first audio segment.

19. The method of claim 17, wherein the web page comprises at least one of:
a recorder enabling the recording of the voice message;
a selection area allowing the user to select a soundscape from the plurality of soundscapes; or,
a player enabling at least one of: playing a soundscape, playing the voice message, and playing the audio clip.

20. The method of claim 19, wherein the selection area provides a list of soundscape genres and a list of soundscapes within the soundscape genre selected by the user.

21. The method of claim 19, wherein the selection area provides a list of soundscape genres, each genre providing a list of editions, each edition providing a list of soundscapes within the soundscape edition of the soundscape genre selected by the user.

22. The method of claim 17, wherein the destination comprises one of: an internet protocol address, an e-mail address, a telephone number, a voicemail box, or a database storage.

23. The method of claim 22, further comprising:
accessing a voicemail box of the user by using access information received from the user.

24. The method of claim 17, further comprising:
providing a unique universal resource locator to the audio clip.

25. A web server comprising:
means for connecting the web server to a first server, the first server enabled to mix a first audio segment, the first audio segment being a voice message, and a second audio segment, the second audio segment being a soundscape, wherein the length of the second audio segment is longer than the first audio segment, where the volume of said second audio segment is lowered to a bed volume with respect to the volume of said first audio segment, thereby creating an audio clip;
means for connecting the web server to the world-wide web (WWW);
memory containing a web page for display on a user terminal; and,
means for accessing the web server to enable the user's browser to display the web page that enables the user to interface with the web server, the web pages containing at least one of:
a recorder enabling the recording of the voice message;
a display allowing the user to select the soundscape from a plurality of soundscapes; or,
a player enabling at least one of: playing a soundscape, playing the voice message, or playing the audio clip.

26. The web server of claim 25, wherein the display allowing the user to select a soundscape from a plurality of soundscapes provides a list of soundscape genres, each genre providing a list of soundscapes within the soundscape genre selected by the user.

27. The web server of claim 25, wherein the display allowing the user to select a soundscape from a plurality of soundscapes provides a list of soundscape genres, each genre providing a list of editions, each edition providing a list of soundscapes within the soundscape edition of the soundscape genre selected by the user.

28. The web server of claim 25, further comprising:
means for interfacing to an e-mail system.

29. The web server of claim 28, wherein the means for interfacing to the e-mail system is enabled to send the audio clip to an email address specified by the user.

30. The web server of claim 25, further comprising:
means for interfacing to an IP telephony system.

31. The web server of claim 30, wherein the means for interfacing to the IP telephony system is enabled to send the audio clip to one of: an IP telephone, or an IP telephone voicemail box.

32. The web server of claim 25, further comprising:
a unique universal resource locator (URL) for the audio clip.

33. The web server of claim 25, wherein the bed volume is between 10 and 18 dB below the volume level of the first audio segment.
